(19) United States
(12) Patent Application Publication
(10) Pub. No.: US 2023/0229220 A1
(43) Pub. Date: Jul. 20, 2023

(54) Systems and Methods for Predicting Power Converter Health

(71) Applicant: ABB Schweiz AG, Baden (CH)

(72) Inventors: Harish Suryanarayana, Apex, NC (US); Goran Mandic, Wake Forest, NC (US); Eddy C. Aeloiza, Apex, NC (US)

(73) Assignee: ABB Schweiz AG, Baden (CH)

(21) Appl. No.: 17/577,891

(22) Filed: Jan. 18, 2022

(51) Int. Cl. G06F 1/30; G06F 11/07

(52) U.S. Cl. CPC G06F 1/30; G06F 11/0793; G06F 11/0721

(57) ABSTRACT

A method for predicting power converter health is provided. The method comprises receiving a plurality of parameter measurements associated with a power converter system comprising a power converter. The plurality of parameter measurements comprises a first set of system measurements and a second set of failure precursor measurements. The method further comprises inputting the first set of system measurements into a first machine learning algorithm to generate expected failure precursor measurement information and inputting the expected failure precursor measurement information and the second set of failure precursor measurements into a second machine learning algorithm to generate component failure prediction information. The method also comprises performing one or more actions based on the generated component failure prediction information.

### FIELD

The present disclosure relates to a method and system for predictive maintenance and control of power electronics converter systems (e.g., an uninterruptible power supply (UPS) and/or motor drives) using one or more parameters (e.g., temperature measurements, failure precursor sensing measurements, other measurements from a power converter) and machine learning (ML)/artificial intelligence (AI) algorithms or models.

### BACKGROUND

Power converters may be and/or include an electrical and/or electro-mechanical device that is used for converting electrical energy. For instance, a power converter may convert alternating current (AC) to direct current (DC) and/or vice versa. Additionally, and/or alternatively, the power converter may also adjust the voltage, current, frequency of the current, and/or other electrical characteristics prior to providing the adjusted electrical characteristics to a load. Power converter systems may include a plurality of components such as circuits, semiconductors, transistors, fans, and/or other types of devices/components that are used for converting electrical energy.

During the lifetime of the power converter system, the components of the power converters may degrade over time, which may lead to problems such as downtime of the converter. For instance, the semiconductors within the power converters may degrade after a period of time, which may lead to power electronic system failures. By being able to determine when a component is likely to fail, then predictive maintenance may be performed to reduce or even prevent system failures. Traditionally, the status of electrical components such as health and lifetime estimation is performed by using complex physical models of the components. They are often extracted from empirical data and require a very deep understanding of the component's failure mechanisms. They are developed once and rarely updated. Since it's very difficult to reproduce all possible field conditions in a lab, they are prone to inaccuracies when in the field. In addition, they rely on historical electrical data (for example, how long a device has been working at certain current level and at a specific ambient temperature) but not on the real present condition of variables that will give an indication of health deterioration (failure precursor). Accordingly, there remains a technical need to predict with high accuracy the health status and remaining useful lifetime of the components within a power converter so as to be able to perform predictive maintenance.

### SUMMARY

A first aspect of the present disclosure provides a method for predicting power converter health. The method includes: receiving, by a system, a plurality of parameter measurements associated with a power converter system comprising a power converter, wherein the plurality of parameter measurements comprises a first set of system measurements and a second set of failure precursor measurements; inputting, by the system, the first set of system measurements into a first machine learning algorithm to generate expected failure precursor measurement information; inputting, by the system, the expected failure precursor measurement information and the second set of failure precursor measurements into a second machine learning algorithm to generate component failure prediction information; and performing, by the system, one or more actions based on the generated component failure prediction information.

According to an implementation of the first aspect, the first machine learning algorithm is a first neural network, and the second machine learning algorithm is a second neural network.

According to an implementation of the first aspect, receiving the plurality of parameter measurements comprises: receiving the first set of system measurements from one or more first sensors of the power converter system; and receiving the second set of failure precursor measurements from one or more second sensors of the power converter system.

According to an implementation of the first aspect, the power converter comprises a rectifier and an inverter, wherein the rectifier comprises a plurality of first semiconductor devices and the inverter comprises a plurality of second semiconductor devices, and the second set of failure precursor measurements are measurements associated with the plurality of first semiconductor devices and the plurality of second semiconductor devices.

According to an implementation of the first aspect, the component failure prediction information indicates degradation of one or more semiconductor devices from the plurality of first semiconductor devices or the plurality of second semiconductor devices.

According to an implementation of the first aspect, the method further comprises: providing, by the system and to a back-end computing system, a request for the first machine learning algorithm and the second machine learning algorithm, wherein the back-end computing system performs initial training of the first machine learning algorithm and the second machine learning algorithm; and receiving, by the system and from the back-end computing system, the first machine learning algorithm and the second machine learning algorithm.

According to an implementation of the first aspect, the method further comprises: performing, by the system, additional training of the first machine learning algorithm based on obtaining a plurality of training measurements from one or more sensors of the power converter system.

According to an implementation of the first aspect, the request indicates a particular type of the power converter that is within the power converter system.

According to an implementation of the first aspect, performing the one or more actions comprises providing the component failure prediction information to a back-end computing system.

According to an implementation of the first aspect, performing the one or more actions comprises increasing a speed of a fan within the power converter system.

According to an implementation of the first aspect, performing the one or more actions comprises minimizing a current draw for a component within the power converter system that is identified by the component failure prediction information.

According to an implementation of the first aspect, the component failure prediction information indicates one or more probabilities of failure for one or more components of the power converter system.

According to an implementation of the first aspect, the component failure prediction information indicates a probability of failure for the power converter system.

According to an implementation of the first aspect, the component failure prediction information indicates a remaining useful life estimation of the power converter.

According to an implementation of the first aspect, performing the one or more actions based on the generated component failure prediction information comprises triggering an action to modify a mode of operation of the power converter.

A second aspect of the present disclosure provides a power converter system. The power converter system comprises a power converter and a power converter control system. The control system is configured to: receive a plurality of parameter measurements associated with the power converter system, wherein the plurality of parameter measurements comprises a first set of system measurements and a second set of failure precursor measurements; input the first set of system measurements into a first machine learning algorithm to generate expected failure precursor measurement information; input the expected failure precursor measurement information and the second set of failure precursor measurements into a second machine learning algorithm to generate component failure prediction information; and perform one or more actions based on the generated component failure prediction information.

According to an implementation of the second aspect, the first machine learning algorithm is a first neural network, wherein the second machine learning algorithm is a second neural network.

According to an implementation of the second aspect, the power converter comprises a rectifier and an inverter, wherein the rectifier comprises a plurality of first semiconductor devices and the inverter comprises a plurality of second semiconductor devices, wherein the second set of failure precursor measurements are measurements associated with the plurality of first semiconductor devices and the plurality of second semiconductor devices.

According to an implementation of the second aspect, the component failure prediction information indicates degradation of one or more semiconductor devices from the plurality of first semiconductor devices or the plurality of second semiconductor devices.

A third aspect of the present disclosure provides a non-transitory computer-readable medium having processor-executable instructions stored thereon. The processor-executable instructions, when executed by one or more processors, facilitate: receiving a plurality of parameter measurements associated with a power converter system comprising a power converter, wherein the plurality of parameter measurements comprises a first set of system measurements and a second set of failure precursor measurements; inputting the first set of system measurements into a first machine learning algorithm to generate expected failure precursor measurement information; inputting the expected failure precursor measurement information and the second set of failure precursor measurements into a second machine learning algorithm to generate component failure prediction information; and performing one or more actions based on the generated component failure prediction information.

### BRIEF DESCRIPTION OF THE DRAWINGS

Embodiments of the present disclosure will be described in even greater detail below based on the exemplary figures. The present disclosure is not limited to the exemplary embodiments. All features described and/or illustrated herein can be used alone or combined in different combinations in embodiments of the present disclosure. The features and advantages of various embodiments of the present disclosure will become apparent by reading the following detailed description with reference to the attached drawings which illustrate the following:

FIG. 1 illustrates a simplified block diagram depicting an environment for predicting the health of one or more power converters according to one or more examples of the present disclosure;

FIG. 2 is a simplified block diagram of one or more devices or systems within the exemplary environment of FIG. 1;

FIGS. 3A and 3B illustrate an example of a power converter system according to one or more examples of the present disclosure;

FIG. 4 illustrates an exemplary block diagram for predicting the health of a power converter system according to one or more examples of the present disclosure;

FIG. 5 depicts another exemplary process for predicting the health of the power converter system in accordance with one or more examples of the present application.

### DETAILED DESCRIPTION

In some instances, the present disclosure provides a system and method to determine (e.g., predict) the health status of a power converter such as predicting component failure prediction probabilities. For example, the present disclosure may determine component failure prediction information that indicates a probability (e.g., 0.7 or 70%) of whether one or more components of the power converter and/or the power converter system is likely to fail. The present disclosure may determine the health status of the power converter by using a combination of sensing (e.g., sensor measurements) in the power converter system and predictive ML/AI techniques, models, and/or algorithms. Additionally, and/or alternatively, the present disclosure may determine the health status of the power converter system for a variety of use cases (e.g., multiple different types of converters) and environments.

In some examples, the present disclosure determines changes (e.g., anomalies and/or device degradation) within the power converter system. For instance, the present disclosure may compare a set of expected measurements (e.g., expected failure precursor measurements) and a set of actual measurements (e.g., actual failure precursor measurements) to determine whether the changes within the power converter are caused by degradation or by another reason such as differences in fan speed, converter loading, different thermal paste used, difference in semiconductor lot, and so on. Additionally, and/or alternatively, in response to determining that the changes are caused by degradation, the present disclosure may take control actions to prolong converter system life. These control actions may include, but are not limited to, displaying information on a display device such that predictive maintenance can occur (e.g., displaying information such that an operator may be aware of the situation and replace the component that is failing). Additionally, and/or alternatively, the system and method may perform one or more control actions such as providing instructions to the power converter system to increase the speed of a fan and/or maximize the amount of current a component can draw.

In other words, certain components within a power converter may degrade over time. One such component that degrades over time is a semiconductor device, and when the semiconductor degrades over time, this may lead to power electronic system failures. However, traditional methods of predicting semiconductor degradation may prove challenging and prone to errors. Nevertheless, if left untreated, the losses (e.g., power losses) caused by the semiconductor device may change (e.g., increase) over time, which causes certain systems (e.g., power converter systems such as an uninterruptible power supply (UPS)) that may require very high up-time and reliability to fail over time.

The present disclosure uses one or more machine learning (ML) and/or artificial intelligence (AI) techniques or models to determine or predict the degradation of one or more components of a power converter. For example, a temperature measured near the device's heat sink may depend on multiple factors such as load current, fan-speed, location, ambient conditions, and so on. Based on historical and simulation data being available when the power converter is performing normally, anomalies due to degradation may be detectable with appropriate failure precursors, system condition monitoring through existing sensors, and ML/AI techniques. In some instance, an extremely high data-sampling rate (e.g., in the order of micro-seconds) might not be needed for many measurements. In some variations, the power converter system may be a modular UPS, and a detected anomaly of the modular UPS may be assigned a lower load (control action and feedback) so as to prolong UPS up-time before replacement. This may be extended to other converters systems. In other words, the present disclosure may determine a detected anomaly using one or more ML/AI techniques, and may perform one or more control actions based on the detected anomaly such as assigning a lower load to a component indicated by the anomaly. In some instances, the power converter system may be and/or include another type of power converter, and the present disclosure may perform a similar role (e.g., detect anomalies and perform control actions). In some examples, the temperature may be used as a measurement determine the anomaly. In other examples, other failure precursor-based degradation approaches may be used for the components of the power converter such as capacitors, semiconductors, batteries, and/or other components.

In some instances, the present disclosure may determine that the appropriate change in temperature or other failure precursors is caused due to degradation of the device, and not due to other system changes such as fan speed, load, and so on. For instance, the measured temperature may change slowly, but other system variables such as load, fan speed, and so on may change at a much faster rate. The present disclosure may use the sensor information associated with the power converter to determine the anomalies, which is available to a control system (e.g., controller) operatively coupled to the power converter system. The control system may be configured to control the power converter and use a very high sampling rate for power electronic control functions. In some examples, the control system may include “embedded-on-microcontrollers” that are used to determine the anomalies. These microcontrollers may be able to securely obtain and process this data. In some instances, the control system, including the microcontroller, may perform the bulk of the “intelligence/thinking” in determining the anomalies, due to the amount of data that may be processed. The control system may further upload the status information (e.g., the detected anomalies and/or other information) to a cloud server. Additionally, and/or alternatively, in some variations, the cloud server may perform the bulk of the “intelligence/thinking” in determining the anomalies.

In some instances, the present disclosure uses actual historical measured data to determine baseline normal operation of a power converter. Using the baseline normal operation of the power converter, the present disclosure uses analytics and intelligence (e.g., ML/AI models) to detect anomalies related to device degradation. The present may be used for many similar devices in the power converter system (e.g., modular multi-level converters (MMC) or multi-level converter systems). The operation of determining the anomalies within the power converter will be described in further detail below.

Exemplary aspects of predicting the health of one or more power converters, according to the present disclosure, are further elucidated below in connection with exemplary embodiments, as depicted in the figures. The exemplary embodiments illustrate some implementations of the present disclosure and are not intended to limit the scope of the present disclosure.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

Where possible, any terms expressed in the singular form herein are meant to also include the plural form and vice versa, unless explicitly stated otherwise. Also, as used herein, the term “a” and/or “an” shall mean “one or more” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on”.

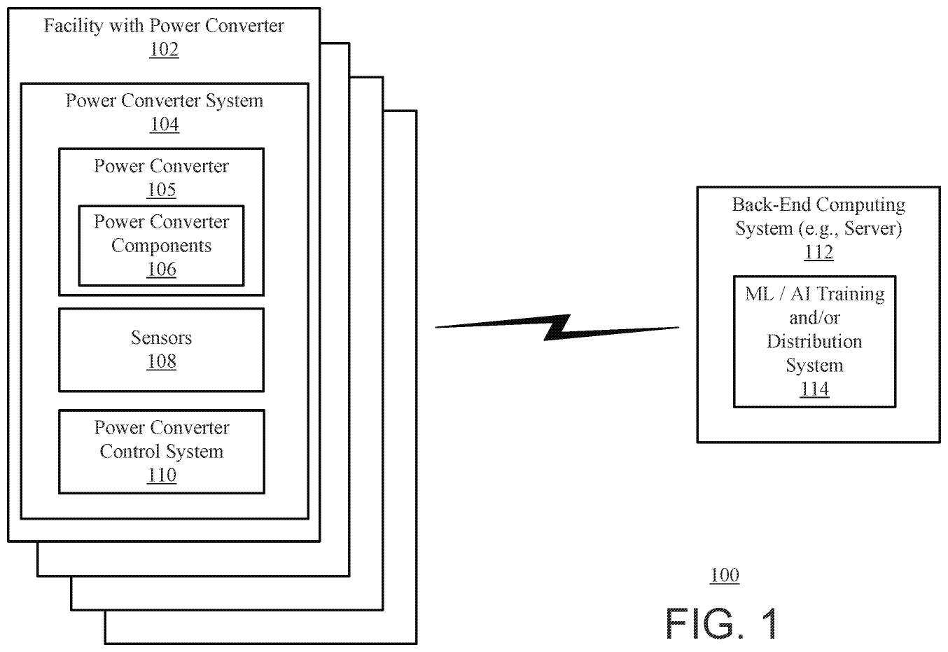

FIG. 1 illustrates a simplified block diagram depicting an environment for predicting the health of one or more power converters according to one or more examples of the present disclosure.

Referring to FIG. 1, environment 100 includes a plurality of facilities with one or more power converters 102 and a back-end computing system 112 (e.g., a server). Each facility 102 includes a power converter system 104 that includes a power converter 105, sensors 108, and a power converter control system 110. The power converter 105 includes power converter components 106. The sensors 108 are configured to obtain and provide sensor information associated with the power converter system 104 to the power converter control system 110. For instance, the sensors 108 may be configured to measure sensor information for one or more components 106 of the power converter 105. Although the entities within environment 100 may be described below and/or depicted in the FIGs. as being singular entities, it will be appreciated that the entities and functionalities discussed herein may be implemented by and/or include one or more entities.

The entities within the environment 100 such as the facility 102 (e.g., via the control system 110) and the back-end computing system 112 may be in communication with each other and/or other entities via a network. The network may be a global area network (GAN) such as the Internet, a wide area network (WAN), a local area network (LAN), or any other type of network or combination of networks. The network may provide a wireline, wireless, or a combination of wireline and wireless communication between the entities within the environment 100.

The facility 102 is any type of building, establishment, location and/or facility that includes or houses at least one power converter system 104 and at least one power converter 105. For example, the facility 102 may be an industrial center that uses a power converter 105 to convert electrical energy. The power converter system 104 is any type of system that includes one or more power converters 105. The power converter system 104 and/or the power converter 105 may include a plurality of components (e.g., power converter components 106). For instance, the components may be and/or include, but are not limited to, semiconductor devices, fans, capacitors, printed circuit boards (PCBs), bus bars, inductors, enclosures, batteries, and/or other components used for power conversion. Non-limiting examples of power converter systems 104 include a UPS system, a modular UPS system or module, a cabinet-built single drive system, and so on.

The power converter 105 is any type of device that processes electrical power from one type of electrical power source to another. For instance, the power converter 105 may convert electrical energy from AC to DC or vice versa. Additionally, and/or alternatively, the power converter 105 may convert from one voltage level to another voltage level, convert DC voltage to a similar or different DC voltage, operate in single-phase or three-phase, operate at voltages greater than 100 Volts (V), and/or operate at power levels greater than 1 kiloWatt (kW)/1 kilo Volt Amps (kVA).

The power converter 105 includes a plurality of power converter components 106. The plurality of power converter components 106 of the power converter 105 include, but are not limited to, semiconductor devices, fans, capacitors, PCBs, bus bars, inductors, enclosures, batteries, and so on.

The power converter system 104 also includes one or more sensors 108 that are configured to obtain sensor measurements for the power converter system 104 and/or the power converter 105. For example, the sensors 108 may be configured to obtain system inputs such as, but not limited to, voltages (e.g., measured voltages at the input, output, DC bus), current (e.g., measured current at the input, output, DC bus), power (e.g., active power at the input, output, and/or DC bus as well as reactive power at the input, output, and/or the DC bus), and/or temperature measurements (e.g., ambient temperature (Ta) for the facility 102/the power converter system 104 as well as temperature measurements at different locations in the power converter system 104) for the power converter system 104. Further, the sensors 108 may be configured to obtain failure precursor measurements such as, but not limited to, semiconductor junction temperature (Tj), current passing through a semiconductor switch (Ig), the voltage (Vds/Vce) across a semiconductor switch's drain-source (for metal-oxide-semiconductor field-effect transistors (MOSFETs)) or collector-emitter (for insulated-gate bipolar transistors (IGBTs), and/or thermal resistance (Rth) observed at different locations.

The sensors 108 provide sensor data (e.g., sensor measurements) to the control system 110. The control system 110 may be and/or include, but is not limited to, an internet of things (TOT) device, controller, processor, field programmable gate arrays (FPGAs) microprocessor, microcontroller, or any other type of computing device that generally comprises one or more processing components and one or more memory components. The control system 110 may be configured to obtain the sensor data from the sensors 108, control the power converter system 104 and/or the power converter 105, determine anomalies (e.g., component failure prediction information), and/or communicate with another entity within environment 100 such as the back-end computing system 112.

The control system 110 may use one or more ML/AI models to determine one or more anomalies within the power converter system 104, and perform one or more control actions based on the one or more anomalies. For example, the control system 110 may receive a plurality of measurements (e.g., sensor measurements) associated with the power converter system 104 and/or the power converter 105. The plurality of measurements may include a first set of measurements and a second set of measurements. In some instances, the first set of measurements are general measurements that may be associated with normal system operations (e.g., the first set of measurements might not be specifically for predictive maintenance or failure estimation). The second set of measurements may be specifically meant to quantify component degradation or failure. For instance, the second set of measurements may be measured quantities that are failure precursors (e.g., the failure precursors may be derived from the second set of measurements. In other words, the first set of measurement are not directly related to the component degradation, but to general operating conditions of a converter (e.g., input/output voltages, currents, power, power factor, temperature, and so on). In some examples, one or more measurements (e.g., temperature) may be part of both the first set of measurements and the second set of measurements.

The control system 110 may input the first set of measurements into a first ML/AI model to generate expected failure precursor parameter measurements (e.g., failure precursor parameter estimates). For example, given certain measurements such as an ambient temperature and/or input/output current of the power converter system 104, the control system 110 may use the first ML/AI model (e.g., a first neural network) to determine an expected failure precursor parameter measurement such as an expected gate current or a voltage between a drain and source of a transistor or semiconductor device of the power converter system 104. Afterwards, the control system 110 may input the expected failure precursor parameter measurement and an actual failure precursor parameter measurement (e.g., from the second set of measurements) into a second ML/AI model (e.g., a second neural network) to generate one or more component failure prediction probabilities. The component failure prediction probabilities may indicate anomalies within the power converter system 104 (e.g., a particular component is failing, which may cause downtime). Based on the component failure prediction probabilities, the control system 110 may perform one or more control actions. For instance, the control system 110 may provide the detected anomaly to a cloud server (e.g., the back-end computing system 112) and/or display the detected anomaly on a display device either at the facility 102 and/or at the cloud server. Additionally, and/or alternatively, the control system 110 may provide instructions to the power converter system 104 and/or other systems/devices so as to prolong the up-time of the power converter 105.

In other words, the control system 110 may obtain two sets of measurements—a first set of measurements (e.g., measured voltages or current at the input, output, or DC bus of the power converter system 104) and a second set of measurements (e.g., a semiconductor junction temperature Tj). The control system 110 uses two ML/AI models (e.g., two neural networks (NN)) to determine anomalies within the power converter system 104. For instance, the control system 110 may use the first ML/AI model to determine expected measurements. Then, the control system 110 may use the second ML/AI model to compare the expected measurements with the actual measurements (e.g., the second set of measurements) to determine whether there are any component anomalies within the power converter system 104.

To put it another way, in some variations, during normal operating conditions (e.g., when the power converter system 104 is operating normally), the first set of measurements may affect the second set of measurements. For instance, the first set of measurements may indicate the ambient temperature of the facility 102 and/or other temperature measurements at different locations in the power converter system 104. The ambient temperature may affect the operational status of a component within the power converter system 104 such as a semiconductor device. The control system 110 may input the ambient temperature and/or other sensor measurements (e.g., other temperature measurements or voltage/current measurements) into the first ML/AI model to generate expected failure precursor parameter measurements (e.g., an expected Tj for the semiconductor device). The expected measurement may indicate an expected value the measurement (e.g., the Tj) should be given the ambient temperature, the input/output voltage, the input/output current, and/or other measurements.

After generating the expected failure precursor parameter measurements, the control system 110 may input the expected failure precursor parameter measurements as well as the second set of measurements (e.g., the actual failure precursor parameter measurements) into a second ML/AI model. For example, the sensors 108 may include a sensor that measures the semiconductor junction temperature Tj of the semiconductor device for the power converter 105. The control system 110 may input the expected semiconductor junction temperature from the first ML/AI model as well as the actual semiconductor junction temperature that was measured by the sensors 108 into the second ML/AI model to generate component failure prediction information. The component failure prediction information may indicate whether a particular component (e.g., the semiconductor associated with the semiconductor junction temperature) is failing. For example, the component failure prediction information may indicate an anomaly associated with the power converter 105 such as the actual semiconductor junction temperature measurement the semiconductor is significantly different from the expected semiconductor junction temperature measurement. For instance, the component failure prediction information may identify one or more components as potentially failing and a probability associated with the identification (e.g., 0.8 or 80%).

Based on the component failure prediction information, the control system 110 may perform one or more control actions. The control actions may include providing the component failure prediction information to the back-end computing system 112 and/or a display device. For instance, the control system 110 may display a prompt on a display device indicating that the semiconductor device (e.g., the semiconductor associated with the semiconductor junction temperature) may be failing. As such, an operator may replace the semiconductor device during the next scheduled down-time. Additionally, and/or alternatively, the control system 110 may provide instructions to the power converter system 104 to control the operation of the power converter 105 so as to prolong the power converter 105 uptime prior to replacement of the identified component (e.g., the identified semiconductor device). The instructions may include, but are not limited to, minimizing a current draw for the identified component (e.g., for a semiconductor device), increasing the speed of a fan to cool the identified component, and/or perform other actions. Additionally, and/or alternatively, the instructions may include modifying the mode of operation to avoid excessive thermal cycles as well as magnitude and/or frequency of thermal swings. Additionally, and/or alternatively, the instructions may include changing the speed of a motor and maintain a safe operating point. In some variations, the converter 105 and/or the converter system 104 may include parallel power modules. As such, the instructions may include shutting down and/or transferring the load to other parallel modules based on detecting a potential failure.

The back-end computing system 112 includes one or more computing devices, computing platforms, systems, servers, processors, memory and/or other apparatuses. In some variations, the back-end computing system 112 may be implemented as engines, software functions, and/or applications. In other words, the functionalities of the back-end computing system 112 may be implemented as software instructions stored in storage (e.g., memory) and executed by one or more processors.

The back-end computing system 112 includes an ML/AI training and/or distribution system 114. For instance, the ML/AI training and/or distribution system 114 may perform initial training of one or more ML/AI models. For example, the ML/AI training and/or distribution system 114 may obtain (e.g., receive and/or generate) simulation data associated with one or more power converter systems 104 and/or actual data (e.g., actual sensor measurements) from one or more power converter systems 104. The ML/AI training and/or distribution system 114 may use the simulation data and/or actual data to train the first and/or the second ML/AI models. For example, the simulation data and/or the actual data may include the first set of measurements (e.g., simulated and/or actual input/output current, input/output voltage, ambient temperature, and so on) and the second set of measurements (e.g., simulated and/or actual semiconductor junction temperatures for a plurality of semiconductor devices). After training the first and/or the second ML/AI models, the ML/AI training and/or distribution system 114 may store the initially trained first and/or second ML/AI models in memory. In some instances, the ML/AI training and/or distribution system 114 may include memory for storing the initially trained first and/or second ML/AI models. Additionally, and/or alternatively, the ML/AI training and/or distribution system 114 may store the trained first and/or second ML/AI models in a separate memory device.

The first and/or second ML/AI models may be any type of ML/AI model, algorithm, dataset, and/or technique. For instance, the first and/or second ML/AI models may be an unsupervised ML/AI model, a supervised ML/AI model, and/or a deep learning ML/AI model such as a neural network. In some instances, the first and/or second ML/AI models may be a first neural network and a second neural network. The neural networks may include a plurality of layers, with each layer including one or more nodes. The nodes between the layers may be connected together using weighted values. During the initially training, the ML/AI training and/or distribution system 114 may input the simulation data and/or the actual data into the first and/or the second neural networks. In some instances, the ML/AI training and/or distribution system 114 may use one or more loss functions to train the first and/or second neural networks.

In some examples, the first and/or second ML/AI models may be associated with a particular power converter 105. For instance, each type of power converter 105 may include different types of power converter components 106 (e.g., some types of power converters 105 may include two filters whereas others may include one filter or some types of power converters 105 may change from AC to DC whereas others just change the magnitude of the DC voltage). As such, the ML/AI training and/or distribution system 114 may train and store a first and a second ML/AI model for each type of power converter 105. Depending on the type of power converter 105 at the facility 102, the power converter control system 110 may retrieve a first ML/AI model and a second ML/AI model associated with the power converter 105 at the facility 102.

In some variations, the first and/or second ML/AI models may undergo additional training at the facility 102 and/or the edge (e.g., the back-end computing system 112). For instance, certain environmental conditions and/or other conditions (e.g., different thermal paste used and/or variances in mounting the devices) that are present at the facility 102 may cause differences between the operating conditions of the components 106 of the power converter 105 and/or of the overall system 104. As such, the ML/AI training and/or distribution system 114 may perform initial training of the first and/or second ML/AI models. Then, after obtaining the first and/or second ML/AI models, the power converter control system 110 and/or the back-end computing system 112 may perform additional training of the first and/or second ML/AI models using actual data from the sensors 108. For example, to obtain expected measurements for the power converter system 104, including the second set of measurements (e.g., the Tj at the actual component 106 of the power converter system 104), the power converter control system 110 may perform additional training of the first and/or the second ML/AI models. For instance, the power converter control system 110 may obtain sensor measurements from the sensors 108 and input the sensor measurements to train the first and/or the second ML/AI models. Additionally, and/or alternatively, the power converter control system 110 may provide the obtained sensor measurements to the back-end computing system 112, and the system 112 may input the sensor measurements to continue training the first and/or the second ML/AI models. The training may occur over a certain time period such as for the first few weeks that the power converter 105 is operational. Additionally, and/or alternatively, the training may also occur after one or more components 106 are replaced within the power converter system 104. For instance, based on user input indicating that one or more components 106 have been replaced (e.g., a semiconductor device), the power converter control system 110 may perform re-training of the first and/or second ML/AI models.

It will be appreciated that the exemplary environment depicted in FIG. 1 is merely an example, and that the principles discussed herein may also be applicable to other situations—for example, including other types of devices, systems, and network configurations. For instance, the back-end computing system 112 may perform one or more of the functionalities of the power converter control system 110. For example, the control system 110 may provide the sensor measurements from the sensors 108 to the back-end computing system 112. The back-end computing system 112 may input these sensor measurements into the first and/or the second ML/AI models to generate the component failure prediction information, and/or perform control actions. In other words, a device that is off-site from the facility 102 may predict the health of the power converter system 104.

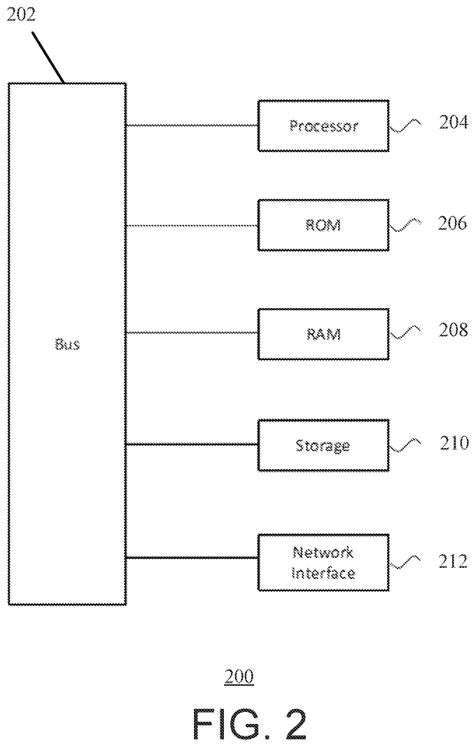

FIG. 2 is a block diagram of an exemplary system and/or device 200 (e.g., a device from the power converter control system 110 and/or the back-end computing system 112) within the environment 100. The device/system 200 includes a processor 204, such as a central processing unit (CPU), controller, and/or logic, that executes computer executable instructions for performing the functions, processes, and/or methods described herein. The processor 204 is not constrained to any particular hardware, and the processor's configuration may be implemented by any kind of programming (e.g., embedded Linux) or hardware design—or a combination of both. For instance, the processor 204 may be formed by a single processor and/or controller, such as general purpose processor with the corresponding software implementing the described control operations. On the other hand, the processor 204 may be implemented by a specialized hardware, such as an ASIC (Application-Specific Integrated Circuit), an FPGA (Field-Programmable Gate Array), a DSP (Digital Signal Processor), or the like.

In some examples, the computer executable instructions are locally stored and accessed from a non-transitory computer readable medium, such as storage 210, which may be a hard drive or flash memory. Read Only Memory (ROM) 206 includes computer executable instructions for initializing the processor 204, while the random-access memory (RAM) 208 is the main memory for loading and processing instructions executed by the processor 204. The network interface 212 may connect to a wired network or cellular network and to a local area network or wide area network, such as the network 106. The device/system 200 may also include a bus 202 that connects the processor 204, ROM 206, RAM 208, storage 210, and/or the network interface 212. The components within the device/system 200 may use the bus 202 to communicate with each other. The components within the device/system 200 are merely exemplary and might not be inclusive of every component, server, device, computing platform, and/or computing apparatus within the device/system 200.

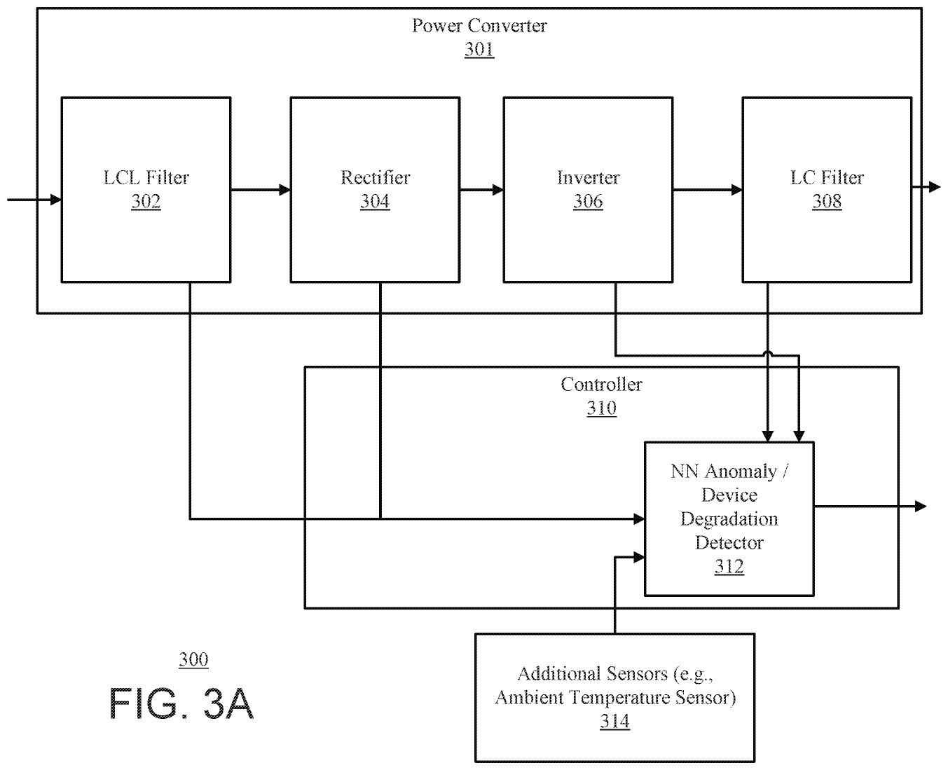

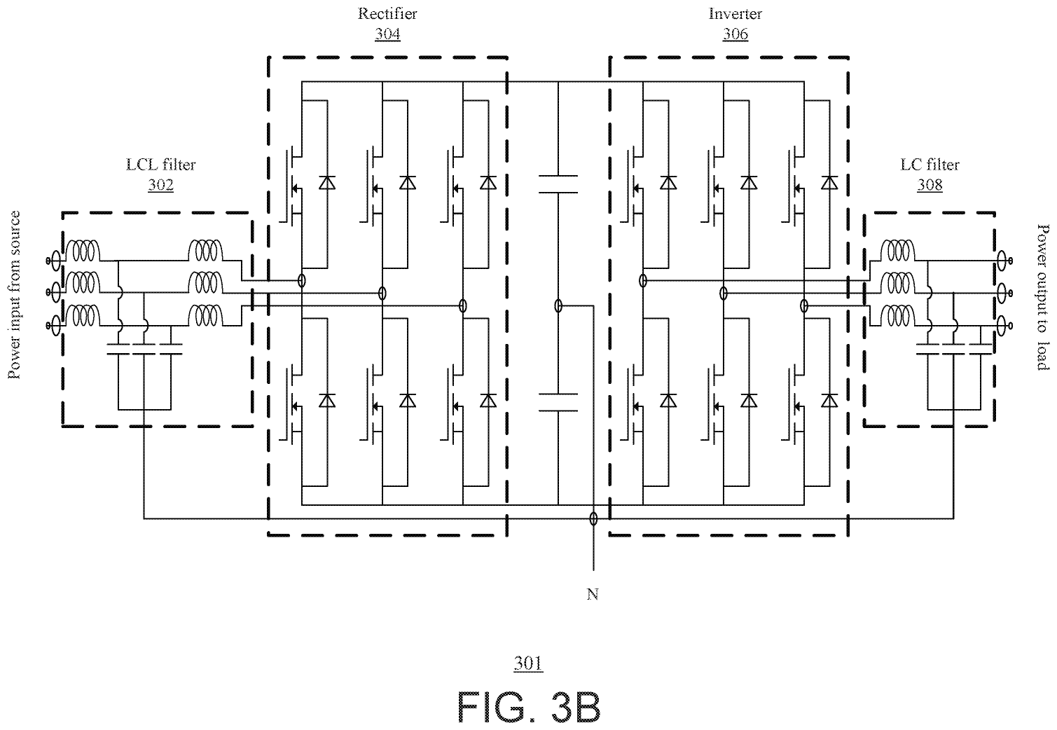

FIGS. 3A and 3B illustrate an example of a power converter system according to one or more examples of the present disclosure. In particular, referring to FIG. 3A, the power converter system 300 includes a power converter 301 and a controller 310. In some instances, the power converter 301 may be the same power converter 105 as shown in FIG. 1. Furthermore, the control system 110 shown in FIG. 1 may include and/or be the controller 310.

The power converter 301 includes an inductor capacitor inductor (LCL) filter 302, a rectifier 304, an inverter 306, and an inductor capacitor filter 308. The LCL filter 302 may be used to remove high frequency harmonics to satisfy voltage total harmonic distortion (THD) or current THD requirements. The rectifier 304 may convert AC power to DC power. The inverter 306 may convert DC power to AC power. The inductor capacitor filter 308 may be used to remove high frequency harmonics to satisfy voltage THD or current THD requirements. The power converter 301 may be operatively coupled to a source (e.g., a power source) and a load. The source may be a power supply (e.g., an AC or DC power supply) or a device/system that is connected to (either directly or indirectly) to a power supply. The load may be any type of load that is configured to use the power from the power converter 301.

FIG. 3B shows an exemplary circuit diagram for the power converter 301. In particular, referring to FIG. 3B, the power converter 301 includes multiple circuit elements such as transistors, inductors, semiconductor devices, capacitors, and so on. The boundaries for the LCL filter 302, the rectifier 304, the inverter 306, and the LC filter 308 are shown as dotted lines.

Referring back to FIG. 3A, the controller 310 includes a neural network (NN) anomaly/device degradation detector (detector) 312. The detector 312 obtains sensor measurements from the devices within the power converter 301 as well as additional sensors 314 (e.g., an ambient temperature sensor). For instance, the detector 312 may obtain input current and voltage measurements (e.g., voltage/current measurements taken prior to the LCL filter 302), output current and voltage measurements (e.g., voltage/current measurements taken after the LC filter 308), DC bus voltage/current from the DC bus, fan speed of one or more fans within the power converter system 300, an ambient temperature measurement, and/or temperature measurements of devices on the heat-sink (e.g., temperature measurements of one or more devices such as semiconductor/transistor devices of the rectifier 304/inverter 306 that are shown in FIG. 3B). In some instances, a sensor may obtain temperature measurements and/or other measurements for multiple devices (e.g., obtain a temperature measurement on a heat sink for multiple devices for low cost products). In some examples, a sensor may obtain temperature measurements and/or other measurements for a single device (e.g., obtain a temperature measurement for each device). The sensor measurements are merely examples, and the controller 310 (as well as the control system 110) may receive additional and/or alternative sensor measurements associated with a power converter 301/105.

After receiving the sensor measurements, the controller 310 (e.g., the detector 312) may input a first set of sensor measurements (e.g., the input/output current and voltage measurements, the DC bus voltage, and the ambient temperature measurement) into a first ML/AI model (e.g., a first NN) to generate expected failure precursor measurement information (e.g., expected temperature measurements of semiconductor devices of the rectifier 304/inverter 306). After generating the expected information, the controller 310 may input the expected information as well as a second set of sensor measurements (e.g., one or more temperature measurements associated with a semiconductor device) into a second ML/AI model (e.g., a second NN) to generate component failure prediction information. Afterwards the controller 310 may perform one or more actions based on the generated component failure prediction information. For instance, the controller 310 may report a detected anomaly (e.g., an anomaly associated with the semiconductor device) to the cloud (e.g., a back-end computing system 112). Additionally, and/or alternatively, the controller 310 may perform (e.g., activate) one or more control actions to prolong the system life.

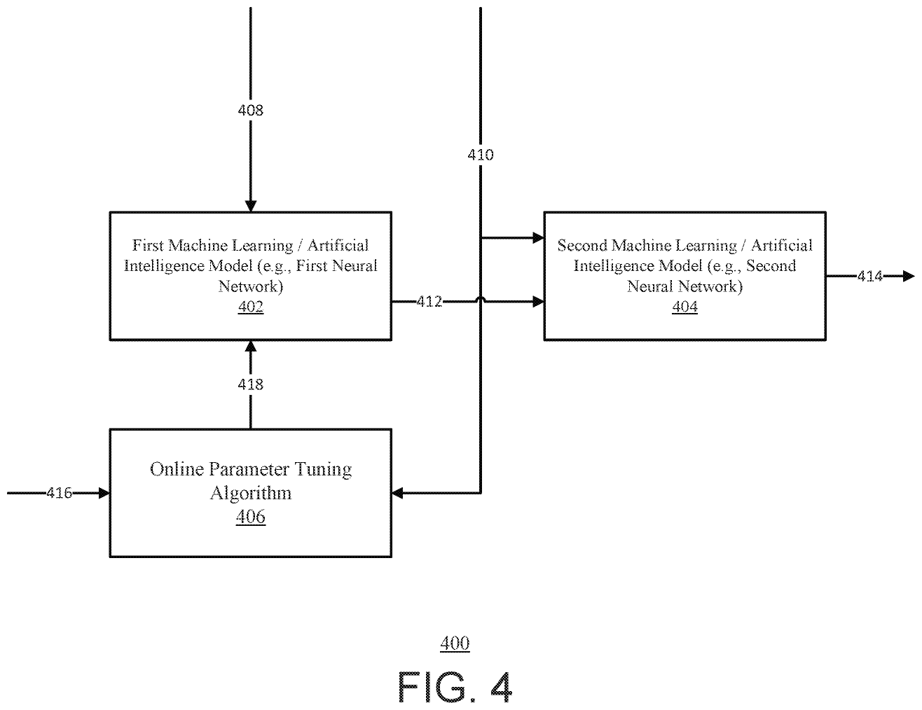

FIG. 4 illustrates an exemplary block diagram for predicting the health of a power converter system according to one or more examples of the present disclosure. The block diagram includes a first ML/AI model (e.g., a first NN) 402, a second ML/AI model (e.g., a second NN), and an online parameter tuning algorithm 406. The control system 110 and/or the controller 310 may use the blocks 402, 404, and 406 to generate component failure prediction information. For example, the controller 310 may store the first NN 402, the second NN 404, and the online parameter tuning algorithm 406 in memory. Then, when called on, the controller 310 may retrieve the first NN 402, the second NN 404, and the algorithm 406 from memory, provide inputs into each of the blocks to generate output information, and send the output information to the next block or entity.

For instance, as mentioned above, initially, a back-end computing system (e.g., the back-end computing system 112 from FIG. 1) trains the first NN 402 and the second NN 404 using actual data from one or more facilities (e.g., the facilities 102 from FIG. 1) and/or simulation data that simulates the sensor measurements from a power converter system. After training is completed (e.g., the accuracy of the first NN 402 and the second NN 404 reaches a pre-determined and/or user-defined threshold), the back-end computing system provides the first NN 402 and the second NN 404 to a facility 102 with a power converter system (e.g., the power converter system 104 and/or 301).

In some examples, the back-end computing system may train a plurality of first NNs 402 and a plurality of second NNs 404. Each of the first NNs 402 and the second NNs 404 may be associated with a particular power converter and/or power converter system. For example, different power converters may include different components (e.g., including MOSFETs or IGBTs) and/or parts (including two filters or one filter). As such, the back-end computing system may train a plurality of NNs 402 and 404 for each of the power converters/power converter systems using simulation data and/or actual data associated with the particular power converter/power converter systems (e.g., the simulation data indicates simulations of a power converter with the same or similar components/parts). Then, the controller 310 may provide a request for a particular first NN 402 and second NN 404 based on the power converter 301 and/or the power converter system 300 that is at the facility. For instance, an operator may provide user input indicating the type of power converter 301 that is at their facility. Based on the user input, the controller 310 may provide a request to the back-end computing system that indicates the type of power converter 301 that is at the facility, and the back-end computing system may provide a particular first NN 402 and second NN 404 associated with the type of power converter 301.

In operation, the controller 310 obtains sensor measurements 408 from the power converter system 300 and inputs the sensor measurements 408 into the first NN 402. The sensor measurements 408 may include the first set of measurements described above (e.g., measured voltages at the input, output, and/or DC bus, measured currents at the input, output, and/or DC bus, active power at the input, output, and/or DC bus, reactive power at the input, output, and/or the DC bus, ambient temperature measurements, and/or additional/alternative measurements). After inputting the sensor measurements 408 into the first NN 402, the first NN 402 outputs expected failure precursor measurements 412.

The controller 310 obtains sensor measurements 410 and inputs the sensor measurements 410 along with the expected failure precursor measurements 412 into the second NN 404. The sensor measurements 410 may include the second set of measurements described above (e.g., the actual failure precursor measurements such as the semiconductor junction temperature, the current passing through a semiconductor switch, the voltage across a semiconductor switch's drain-source or collector-emitter, the thermal resistance observed at different locations, and/or additional/alternative measurements). Based on inputting the sensor measurements 410 and the expected failure precursor measurements 412 into the second NN 404, the NN 404 outputs failure component prediction data information (failure information) 414. The failure information 414 may include, but is not limited to the probability of failure of one or more components of the power converter system 300 and/or the power converter 301, the probability of failure of the power converter system 300 and/or the power converter 301, and/or the remaining useful life estimation of the power converter 301.

For example, in some variations, based on the sensor measurements 408 and 410, and based on the expected failure precursor measurements 412, the controller 310 determines the probability of failure of one or more components of the power converter system 300 and/or the power converter 301. For instance, the controller 310 may use the first ML/AI (NN) model to output estimated precursor parameter values (e.g., expected precursor parameter measurements) based on the converter operating conditions (e.g., voltages, currents, load, and so on). For example, the estimated precursor parameter values may be expected junction temperatures. Then, the controller 310 may input the sensor measurements (e.g., the measured junction temperatures) and expected measurements (e.g., the expected junction temperatures) into the second NN 404 to output the probabilities of failure based on discrepancies between the estimated and actual values. In some examples, the output of the second NN may be the probability of failure at a given time. For instance, if the component that is about to fail continues to operate, the output of the second NN may be a probability (e.g., probability of failure) indicating the likelihood of failure for the component, which may increase over time if no further action is taken.

In some instances, based on the sensor measurements 408 and 410, and based on the expected failure precursor measurements 412, the controller 310 determines the probability of failure of the power converter system 300 and/or the power converter 301. For instance, the controller 310 may use the second NN 402 to determine a plurality of probability of failures for a plurality of components of the power converter 301 and/or the system 300. Then, based on one or more probabilities of particular components (e.g., critical failure probabilities for one or more critical components of the power converter 301 such as semiconductors or capacitors in the power path), the controller 310 may determine the probability of failure for the entire power converter system 300 and/or the power converter 301. For instance, the probability of failure for the entire power converter system 300 and/or the power converter 301 may be based on the highest failure probability for one of these critical components. Additionally, and/or alternatively, the probability of failure for the entire power converter system 300 and/or the power converter 301 may be based on an algorithm or calculation associated with the probability of failures for a plurality of the critical components.

In some examples, based on the sensor measurements 408 and 410, and based on the expected failure precursor measurements 412, the controller 310 determines the remaining useful life estimation of the power converter 301. For instance, based on data collected from the field (e.g., sensor measurements 408 and 410), one or more reliability models, and/or probability of failure for one or more components of the power converter system 300 and/or the power converter 301, the controller 310 may determine the remaining useful life estimation of the power converter 301. Additionally, and/or alternatively, the controller 310 may input the data collected from the field (e.g., sensor measurements 408 and 410) and the reliability model into the second NN, and the output from the second NN may be the remaining useful life estimation.

After obtaining the failure information 414, the controller 310 performs one or more control actions. For instance, the controller 310 may display the failure information 414 on a display device (e.g., display the probability of failure for one or more components of the power converter 301). The controller 310 may further provide control actions to the power converter 301 such as limiting the maximum current draw for the component(s) indicated by the failure information 414 (e.g., limiting the current draw for one or more semiconductor devices).

In some variations, the online parameter tuning algorithm 406 performs additional training of the first NN 402 and/or the second NN 404. For instance, after obtaining the first NN 402 and the second NN 404 from the back-end computing system, the controller 310 may perform additional training of the first and second NNs 402 and 404. For example, each facility may have different operating conditions (e.g., a facility in Texas may have different humidity and year-round temperature differences from a facility in Minnesota) and/or different components, parts, or entities (e.g., different types of semiconductors within the devices such as MOSFETs or IGBTs). As such, the controller 310 may perform additional training so as to determine baseline factors for the first and second NNs 402 and 404. To put it another way, after installation of the power converter 301, an operator at the facility may expect the power converter 301 to operate normally (e.g., there is little to no degradation of the power converter 301 as well as the components such as semiconductor devices within the power converter). As such, the operator may provide user input (e.g., enablement information 416) to the controller 310 indicating additional training of the NNs 402 and 404. Based on receiving the enablement information 416, the controller 310 uses the online parameter tuning algorithm to train the first NN 402 and/or the second NN 404. Additionally, and/or alternatively, the additional training may occur after the power converter 301 has been operational for a certain amount of time. For instance, during a planned downtime, one or more components (e.g., semiconductor components) may be replaced within the power converter 301. As such, the operator may provide enablement information 416 to indicate additional training of the first and/or second NNs 402 and 404.

The controller 310 uses the online parameter tuning algorithm 406 to train the first NN. For instance, the controller 310 may use any type of training algorithm (e.g., backpropagation) to train the first NN 402. The training algorithms may use cost functions to adjust the weights in such a way to decrease its value. In some variations, the controller 310 may only additionally train the first NN and the second NN is not trained additionally. In some instances, the training algorithm is the same and may be performed online rather than using batch backpropagation.

As shown, the controller 310 uses the sensor measurements 410 (e.g., the second set of measurements described above) to perform online tuning for the first NN 402. For instance, based on the sensor measurements 410, the online parameter tuning algorithm 406 may update the weights for the first NN 402 and provide the updated weights 418 to the first NN 402. In other words, the controller 310 may perform online tuning of the first NN 402 using sensor measurements from the facility 102 where the power converter 301 is deployed. Then, the controller 310 may provide the updated weights 418 to the first NN 402 and the first NN 402 may use the updated weights for determining the expected failure precursor measurements 412. Additionally, and/or alternatively, the controller 310 may use the sensor measurements 410, the sensor measurements 408 and/or output from the first NN 402 (e.g., the expected failure precursor measurements 412) to update the first NN 402 (e.g., determine the updated weights 418).

In some examples, block 406 (e.g., the online parameter tuning algorithm) may be incorporated into another entity (e.g., the computing system 112). For instance, the computing system 112 may provide training for the first NN 402 using real-time measurements.

In some variations, the controller 310 may update the second NN 404. For example, the computing system 112 may obtain more data and update the second NN 404. Then, the computing system 112 may push the updated second NN 404 to the facilities 102. The controller 310 may receive the updated second NN 404 and use the updated second NN 404 for determining the failure information 414.

It will be appreciated that the exemplary power converter system depicted in FIGS. 3A and 3B and the block diagram depicted in FIG. 4 are merely examples, and that the principles discussed herein may also be applicable to other situations. For instance, the back-end computing system 112 may perform the blocks of FIG. 4 (e.g., use the first NN 402 and the second NN 404 to determine the failure information 414).

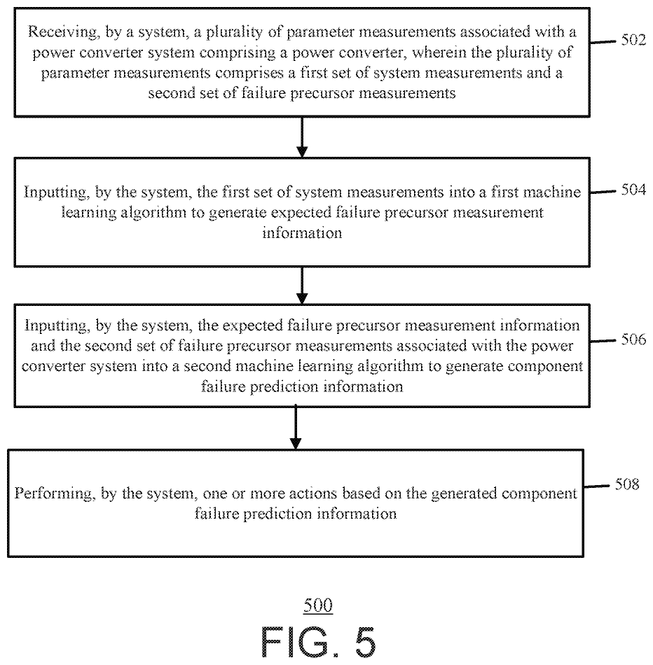

FIG. 5 depicts another exemplary process for predicting the health of the power converter in accordance with one or more examples of the present application. The process 500 may be performed by the control system 110 and/or the back-end computing system 112 shown in FIG. 1. However, it will be recognized that any of the following blocks may be performed in any suitable order and that the process 500 may be performed in any environment and by any suitable computing device. For instance, the process 500 may also be performed by the controller 310 shown in FIG. 3.

At block 502, the system (e.g., the control system 110, the back-end computing system 112, and/or the controller 310) receives a plurality of parameter measurements associated with a power converter system comprising a power converter. The plurality of parameter measurements comprises a first set of system measurements and a second set of failure precursor measurements. At block 504, the system inputs the first of system measurements into a first machine learning algorithm to generate expected failure precursor measurement information. At block 506, the system inputs the expected failure precursor measurement information and the second set of failure precursor measurements associated with the power converter system into a second machine learning algorithm to generate component failure prediction information. At block 508, the system performs one or more actions based on the generated component failure prediction information.

While embodiments of the invention have been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. For example, the various embodiments of the kinematic, control, electrical, mounting, and user interface subsystems can be used interchangeably without departing from the scope of the invention. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A method, comprising:
receiving, by a system, a plurality of parameter measurements associated with a power converter system comprising a power converter, wherein the plurality of parameter measurements comprises a first set of system measurements and a second set of failure precursor measurements;
inputting, by the system, the first set of system measurements into a first machine learning algorithm to generate expected failure precursor measurement information;
inputting, by the system, the expected failure precursor measurement information and the second set of failure precursor measurements into a second machine learning algorithm to generate component failure prediction information; and
performing, by the system, one or more actions based on the generated component failure prediction information.

2. The method of claim 1, wherein the first machine learning algorithm is a first neural network, wherein the second machine learning algorithm is a second neural network.

3. The method of claim 1, wherein receiving the plurality of parameter measurements comprises:
receiving the first set of system measurements from one or more first sensors of the power converter system; and
receiving the second set of failure precursor measurements from one or more second sensors of the power converter system.

4. The method of claim 1, wherein the power converter comprises a rectifier and an inverter, wherein the rectifier comprises a plurality of first semiconductor devices and the inverter comprises a plurality of second semiconductor devices, wherein the second set of failure precursor measurements are measurements associated with the plurality of first semiconductor devices and the plurality of second semiconductor devices.

5. The method of claim 4, wherein the component failure prediction information indicates degradation of one or more semiconductor devices from the plurality of first semiconductor devices or the plurality of second semiconductor devices.

6. The method of claim 1, further comprising:
providing, by the system and to a back-end computing system, a request for the first machine learning algorithm and the second machine learning algorithm, wherein the back-end computing system performs initial training of the first machine learning algorithm and the second machine learning algorithm; and
receiving, by the system and from the back-end computing system, the first machine learning algorithm and the second machine learning algorithm.

7. The method of claim 6, further comprising:
performing, by the system, additional training of the first machine learning algorithm based on obtaining a plurality of training measurements from one or more sensors of the power converter system.

8. The method of claim 6, wherein the request indicates a particular type of the power converter that is within the power converter system.

9. The method of claim 1, wherein performing the one or more actions comprises providing the component failure prediction information to a back-end computing system.

10. The method of claim 1, wherein performing the one or more actions comprises increasing a speed of a fan within the power converter system.

11. The method of claim 1, wherein performing the one or more actions comprises minimizing a current draw for a component within the power converter system that is identified by the component failure prediction information.

12. The method of claim 1, wherein the component failure prediction information indicates one or more probabilities of failure for one or more components of the power converter system.

13. The method of claim 1, wherein the component failure prediction information indicates a probability of failure for the power converter system.

14. The method of claim 1, wherein the component failure prediction information indicates a remaining useful life estimation of the power converter.

15. The method of claim 1, wherein performing the one or more actions based on the generated component failure prediction information comprises:
triggering an action to modify a mode of operation of the power converter.

16. A power converter system comprising:
a power converter; and
a power converter control system configured to:
receive a plurality of parameter measurements associated with the power converter system, wherein the plurality of parameter measurements comprises a first set of system measurements and a second set of failure precursor measurements;
input the first set of system measurements into a first machine learning algorithm to generate expected failure precursor measurement information;
input the expected failure precursor measurement information and the second set of failure precursor measurements into a second machine learning algorithm to generate component failure prediction information; and
perform one or more actions based on the generated component failure prediction information.

17. The system of claim 16, wherein the first machine learning algorithm is a first neural network, wherein the second machine learning algorithm is a second neural network.

18. The system of claim 16, wherein the power converter comprises a rectifier and an inverter, wherein the rectifier comprises a plurality of first semiconductor devices and the inverter comprises a plurality of second semiconductor devices, wherein the second set of failure precursor measurements are measurements associated with the plurality of first semiconductor devices and the plurality of second semiconductor devices.

19. The system of claim 18, wherein the component failure prediction information indicates degradation of one or more semiconductor devices from the plurality of first semiconductor devices or the plurality of second semiconductor devices.

20. A non-transitory computer-readable medium having processor-executable instructions stored thereon, wherein the processor-executable instructions, when executed by one or more processors, facilitate:
receiving a plurality of parameter measurements associated with a power converter system comprising a power converter, wherein the plurality of parameter measurements comprises a first set of system measurements and a second set of failure precursor measurements;
inputting the first set of system measurements into a first machine learning algorithm to generate expected failure precursor measurement information;
inputting the expected failure precursor measurement information and the second set of failure precursor measurements into a second machine learning algorithm to generate component failure prediction information; and
performing one or more actions based on the generated component failure prediction information.
